(19) United States
(12) Patent Application Publication
(10) Pub. No.: US 2009/0076792 A1
(43) Pub. Date: Mar. 19, 2009

(54) TEXT EDITING APPARATUS AND METHOD

(75) Inventor: Hugh Lawson-Tancred, London (GB)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: EMIL LTD, London (GB)

(21) Appl. No.: 12/140,057

(22) Filed: Jun. 16, 2008

Related U.S. Application Data
(63) Continuation-in-part of application No. PCT/GB2006/004735, filed on Dec. 18, 2006.

(30) Foreign Application Priority Data
Dec. 16, 2005 (GB) 0525657.3

(51) Int. Cl. G06F 17/28

(52) U.S. Cl. 704/2

(57) ABSTRACT

A computer apparatus for managing information representing text translated from a first language to a second language, the apparatus comprising: an information store for storing a first set of information representing text translated from a first language to a second language; a user input or interface for receiving user instructions for selection and/or editing of text represented in said first set of information; text data controller for editing said first set on the basis of received user instructions; and a display data generator operable to generate display data, said display data being operable to define first and second display areas on a display medium, said first display area containing first text information corresponding to said first set of information under the control of said text data controller, and said second display area containing second text information corresponding to a second set of information, said second set of information either comprising said text prior to translation from said first language or corresponding to said first set prior to editing thereof by said text data controller; wherein said display data generator being further operable to include distinguishing information in said display data, said distinguishing information being operable to cause a part of said first text information and a corresponding part of said second text information to be visually distinguished from the remaining respective parts of said first and second texts.

### CROSS-REFERENCE TO RELATED APPLICATIONS

The present application is a continuation-in-part from PCT application PCT/GB2006/004735 designating the United States of America (PCT publication number WO2007/068960), and this PCT application is incorporated by reference in the present application.

### BACKGROUND

The present invention relates to text editing apparatus and methods, and in particular, to apparatus and methods for post-editing of text following a translation process from one language to another, or for post-editing of any machine-generated text.

The demand for translation services is increasing beyond the rate of growth of world trade, which is in turn higher than the growth rate of the world economy. More than half of all Internet traffic is now in a language other than English, and the evidence is that the trend towards domination by English in commercial life more generally is slowing down. Recruitment to the translation profession, though increasing, is still not adequate to meet demand. Meanwhile, new technologies in the processing of natural language are raising the prospect of ever greater involvement of the computer in the handling of translation.

There have traditionally been two main approaches to the use of software in natural language translation. The first, machine translation (MT), has been in existence since the 1950s but has failed, so far, to establish itself as a credible basis for mainstream translation. This is likely to change to some extent in the next few years with the increasing use of statistical and stochastic technologies, but MT, despite extensive use on the Internet, has still to achieve widespread acceptance. The principal reason why MT solutions are deemed to be non-viable is that the quality of the machine translation is not sufficiently high for many purposes. MT systems tend to have poorer performance for relatively discursive as against technical translations. This is for a number of reasons. Unrecognised words are not translated, but are simply copied into the translated text; words with several meanings may be translated to give the wrong meaning for the context, and MT systems also decrease in effectiveness as the syntactic structure of the source sentences increases in complexity. By the same token they are less effective between pairs of languages with widely different sentence structure.

This results in the necessity of post-editing a machine translated text, in order to improve the quality to acceptable standards. With present machine translation systems, a large amount of time and effort may be involved to convert the output of the MT system into human-quality translation.

Typically, machine translation software provides a user interface having a first area on a computer screen, into which a user can type or paste text to be translated, and a second area of the screen, in which the machine translation output is shown. One of the most popular currently used MT systems (and also the oldest) is a software package called “Systran”, which allows translation to and from a large selection of languages.

The other principal technology is that of translation memory (TM) systems. Translation memory systems avoid the traditional problems of MT by leaving all actual translation with the human participant and merely providing efficient systems for the reuse of previously translated material (which in certain texts or series of texts is likely to be extensive), thus achieving what is sometimes known as machine-assisted human translation (MAHT). Presently available TM systems are inefficient in that they require “first-time” manual translation of much material which can effectively be handled automatically by the software.

Various TM systems are currently available on the market. For example, the “Trados” TM system is one of the most popular TM systems in use. “Trados” recycles already translated sentences, to avoid repetitive typing by the user, by providing a “workbench” window, which automatically presents the relevant source text sentence and matches it with any matching previous sentence that is available. A system like Trados allows a user to set a desired level of “fuzzy matching”, as a single numerical value, where 100% represents exact matches only. If the fuzziness level is set to below 100%, the system will then display previously translated sentences that partially or exactly match the source text, above the user-set threshold. A useful level of fuzzy matching is 90% or above. Below this threshold, the amount of work in editing the fuzzy matches becomes prohibitively high. However, the system only matches whole sentences, e.g. identified as blocks of text separated by full stops, and does not provide any translation on a word by word or phrase by phrase level.

### SUMMARY

One aspect of the present invention provides a text editing method or apparatus for editing text translated from at least a first language to a second language. The apparatus includes a user input means for receiving user instructions to select and/or edit text. The apparatus includes display data generating means for generating display data to be displayed on a display medium. The apparatus also includes a controller operable to control the display to show user-editable translated text in a first display area, and to display one of the pre-translated text or pre-user-edited translated text in a second display area. The controller is configured to highlight a selected part of the text in the first display area, to highlight a corresponding part of the text in the second display area, and to update said highlighting if a new text selection is obtained via the user input means. Highlighting may comprise the use of bold type, italics, underlining, text colour, background colour, font type, font size etc to differentiate the highlighted text from the surrounding text, preferably without disturbing the formatting of the source text.

The controller may be configured to display the other of said pre-translated text and pre-user-edited translated text in a third display area, and to highlight a part of said text in the third display area corresponding to the selected part of the text in the first display area. The controller may be configured to display one or both of the original pre-translated text and error-corrected pre-translated text, each in said second or third display area or in an additional display area. The controller may be configured to highlight individual parts of the text at a sub-sentential level. The controller may be configured to highlight a first phrase in the first window, and a corresponding second phrase in the second window, and additional words corresponding to translations of said highlighted words, wherein said additional words are located in a different phrase to the first or second highlighted phrases.

A further aspect of the present invention provides a text editing apparatus for the editing of text translated from at least a first language to a second language, the apparatus comprising: user input means; and a controller adapted to identify the language of the pre-translated text and/or post-translated text, and to use said identification of the language(s) to automatically select and/or verify selection of post-editing processes for post-editing of the translated text.

The controller may be configured to identify a sequence of translated languages used to translate said text from at least a first to a second to a third language, and to use said sequence for selection or verification of the selection of post-editing processes.

A further aspect of the present invention provides a text editing apparatus for the editing of text translated from at least a first language to a second language, the apparatus comprising user input means; and a controller adapted to correct errors in the pre-translated text by identifying an input source type of the text and selecting a correction process according to said input source type.

The controller may be configured to implement pre-translation corrections according to an input source type of the pre-translated text. In addition or alternatively, the controller may be configured to implement post-translation corrections according to an input source type of the translated text. The controller may be configured to select one or more processing rules using an identification of the input source type as one of Optical Character Recognition (OCR), audio dictation, or keyboard. The controller may be configured to identify the input source type of said text using statistical analysis.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, wherein said controller comprises pattern detection means for automatic identification of phrases and/or phrase boundaries within said text, and means for automatic selection of an individual phrase to allow said phrase to be restructured or modified in its syntactical and/or lexical properties or to be moved to a different part of the text, for example within the same sentence, on receipt of a predetermined user instruction. Such phrase identification and/or such changes may be recorded and re-used at a later time. This pattern detection function may be supported by syntactic analysis. For example, predetermined grammatical arrangements of words may be detected and used during phrase identification. In some embodiments, the user may configure the syntactic analysis process by selecting parameters which are used to select or prioritise syntactic units. Optionally, the user may also select ordering criteria. The user may also be able to specify personalised settings, for instance highlighting pre-set lexically determined phrase-head/complement relations. The head of the phrase is the word on which the phrase grammatically depends: for instance, to take a very simple case, in “bank of investment” the word bank is the head and the component of investment is the complement. Thus, a possible setting might relate to all phrases with the head-word “certificate”, specifying that the preposition of the complement (standardly “of” but potentially identified merely in terms of category) should be deleted and the noun or noun phrase of the complement (identified only by grammatical category) should be moved to being the first word or component of the phrase. It would, of course, also be possible to have such marker words inside the complement itself so that the change would be made irrespective of the lexical content of the head-word.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, wherein said controller comprises means for identification of phrases and/or phrase boundaries and means for implementing automatic phrase ordering rules particular to a specified language. In some embodiments the sequence of application of the phrase ordering rules may be user specified or altered. These phrase ordering rules may also be capable of context-specific adjustment, e.g. using marker word criteria for the deployment of a specific ordering rule. A marker word or expression may be a word or expression whose presence and position in a phrase marks that phrase as suitable for the application of a macro which reorders the grammatical structure of the phrase irrespective of the lexical content. This enables powerful reordering procedures to be used in specific contexts identified by the marker and prevents the risk of over-generalisation of automated structural changes.

The controller may be configured to construct a sentence structure model by classification of said identified phrases by phrase type. The controller may be configured to flag said identified phrases to indicate said phrase type. The controller may be configured to show highlighting of phrases on said display, according to the phrase type.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, wherein said controller comprises pattern detection means for automatic identification of phrases and/or phrase boundaries within said pre-translated and translated text, and means for identification of words occurring in a first phrase of the pre-translated text and corresponding words occurring in a second phrase of the translated text. The second phrase may contain only some, rather than all, of the material present in the first phrase. The material shared with the first phrase may be a pure string or syntactic/grammatical features, or a combination of these. The controller may identify the corresponding words by matching occurent phrase patterns with template phrase pattern schemata and flagging discrepancies, so as to facilitate manual corrective intervention. The user may be enabled to alter either the local phrase or the template phrase.

A further aspect of the present invention provides a text editing apparatus for the editing of text translated from at least a first language to a second language, the apparatus comprising user input means for receiving user instructions to select and/or edit text; and a controller adapted to control the display to show user-editable translated text, wherein said controller is configured to allow user-instructed drag and drop editing, and to automatically amend the case and/or punctuation of edited text to correspond to the new location of said text in a sentence, which may include appropriate treatment of white space.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, wherein said controller is configured to identify phrases and to verify agreement of number, case and/or gender for nouns and pronouns and compatibility of tense, mood, voice, person and number for verbs within individual phrases.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, wherein said controller comprises means for implementing an autotext function to provide a user with a plurality of options for replacement of selected phrases or words.

The autotext function may be provided for words that have several possible alternative translations. The autotext function may be configured to allow the user to cycle through said options for a selected word, using the user interface. The autotext function may be user-customisable to allow a user to pre-define said options. The autotext function is configured to obtain said options from an external source. The autotext function may be fully integrable with on-line dictionary access, such that an on-line dictionary entry can either be used in a global replacement, entered in a stored profile or assigned to an autotext marker for ease of occasional use. Autotext entries may be fully searchable on a range of arbitrarily selected search criteria.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, comprising means for identifying translated words with multiple possible meanings, and offering a replacement of the alternate possible meanings, for selection by a user. User selection may be effected through local drop-down lists and may be suppressible for individual words/phrases.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, comprising means for automatically inserting, into the translated text, grammatical structures that are characteristic of the second language but not of the first language. This may work approximately according to the principle of a conventional style-checker, but with stylistic parameters set explicitly to correlate with the specific problems of machine text output. The grammatical structures to be inserted may be derived either from the previous processing of the same or similar texts or from a generalised language model, either generated from within the system or imported into the system from compatible external sources.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, comprising means for automatically removing, from the translated text, grammatical structures that are characteristic of the first language but not of the second language. The processing approach may be the precise converse of that described in the previous paragraph. Thus the grammatical structures to be removed may be determined by the previous processing of the same or similar texts or by a generalised language model, either generated from within the system or imported into the system from compatible external sources.

The controller may be configured to implement a string-replacement function with fuzzy matching. The controller may be configured to implement a parsed pattern recognition and replacement function.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, comprising automatic means for grammar and style adjustment, for implementation after receiving an input to indicate that the user editing is complete. This process may also be open to user monitoring and possible user intervention. The grammar, style and readability tools may be similar to existing “authoring software”, but more closely specific to the stylistic problems likely to derive from the original source language. It may also be customisable to a much greater extent by the user, possibly in the light of client requests. In one embodiment, the user will be offered stylistic profiles, providing the possibility that text translated in the same way might be presented stylistically in different ways for different recipients. This is distinctive from the previously discussed structural rearrangements in being intended to promote variety and readability rather than simple intelligibility.

A further aspect of the present invention provides a text editing apparatus for the editing of text translated from at least a first language to a second language, the apparatus comprising: user input means for receiving user instructions to select and/or edit text; and a controller adapted to control the display to show user-editable translated text, the controller comprising means for storing a plurality of text editing procedures and compiling and saving lists of said procedures for use with different input texts. The procedures may be referred to as “profiles”.

A further aspect of the invention provides a text editing apparatus for the editing of text translated from at least a first language to a second language, the apparatus comprising: user input means for receiving user instructions to select and/or edit text; and a controller adapted to control the display to show user-editable translated text, the controller comprising means for storing, accumulating, editing and combining information defining text-editing procedures, and means for sharing of said stored information defining the text-editing procedures among a plurality of users. The plurality of users may access the information locally or via one or more networks.

In any of these aspects of the invention, the controller may be configured to select and implement automatic editing processes to apply a selected orthography to a translated text. Also, the controller may be configured to implement selected automatic editing processes for formatting of figures and/or dates. The controller may be configured to apply selected automatic editing processes to a plurality of documents. In any of these aspects of the invention, the text editing apparatus may be a computer apparatus. The controller may be a computer processor, configured for performing the functions of any of the described aspects of the invention.

A further aspect of the present invention provides a profile management system or method for management of profiles comprising sets of rules for post-editing a translated text. The lists may each be categorised according to suitability of use with a particular type of text or language. A preferred major feature of the use of the software is the editing and combination of profiles to form new profiles for enhancing post-editing in areas not previously handled. It is envisaged that in some cases, skilful combination of profiles will progressively replace the need to conduct a human post-editing run at all. These profiles will also be able to constitute independent intellectual property.

The profiles may evolve through parallel use by multiple users, with integration and vetting of the profiles. The profile management system may provide an easy means of registering differences between profiles and may be configurable to make systematic editorial changes to profile contents. It may also be possible for profile-constituent macros to be grouped and deployed in any arbitrarily chosen combination.

A further aspect of the invention provides a method and apparatus for managing information representing computer generated text. The apparatus includes information storage means for storing a first set of information representing said computer generated text; user input means for receiving user instructions for selection and/or editing of text represented in said first set of information; text data control means for editing said first set on the basis of received user instructions; and display data generating means operable to generate display data, said display data being operable to define first and second display areas on a display medium, said first display area containing first text information corresponding to said first set of information under the control of said text data control means, and said second display area containing second text information corresponding to a second set of information, said second set of information corresponding to said first set prior to editing thereof by said text data control means. The display data generating means is further operable to include distinguishing information in said display data, said distinguishing information being operable to cause a part of said first text information and a corresponding part of said second text information to be visually distinguished from the remaining respective parts of said first and second texts. Any of the features described in relation to aspects of the invention involving translated text may also be applied to or adapted to be used in embodiments for management of computer generated text.

In any aspects of the invention, punctuation may comprise full stops, commas, colons, semicolons, hyphens, dashes, white space, apostrophes, capitalisation, etc.

In some embodiments, the editing process presupposes a machine translation process. However, considerable benefit of the invention can still be obtained by post-editing of translations obtained from other sources. For example, embodiments of the invention may be used with human translations, e.g. to or from a language in which the translator was not completely fluent. A similar use is also possible for original text produced by a non-native speaker, in which certain recurrent linguistic anomalies can be systematically suppressed. An important range of embodiments is that of those related to text mechanically or computer generated, within a single language, by various kinds of text-processing software, either currently available or to be developed in the future. An example of such software would be “text-mining”, in which specified information is obtained from a (potentially large) document. For example, “text-mining” software may automatically generate summaries of documents, of a length specified by the user. Such generated text may well be the result of machine linguistic synthesis and either require or be able to benefit from post-editing similar to that of machine translation.

The user input means may be a user input device such as a pointer device (e.g. mouse, trackpad, trackerball, pen, trackpoint device), touchpad, gamepad, game controller, joystick, remote control, touchscreen, keyboard, or keypad (which may have customisable buttons). The display may be a monitor, TV screen, touch screen with buttons, dictation input, any other type of display or any future device.

The present invention can be implemented in dedicated hardware, using a programmable digital controller suitably programmed, or using a combination of hardware and software.

Alternatively, the present invention can be implemented by software or programmable computing apparatus. This includes any computer, such as a desktop computer, laptop computer, handheld computer, PDA (personal digital assistant), mobile phone, etc, or any future device. The code for each process in the methods according to the invention may be modular, or may be arranged in an alternative way to perform the same function. The methods and apparatus according to the invention are applicable to any computer with a network connection.

Thus the present invention encompasses a carrier medium carrying machine readable instructions or computer code for controlling a programmable controller, computer or number of computers as the apparatus of the invention. The carrier medium can comprise any storage medium such as a floppy disk, CD ROM, DVD ROM, hard disk, magnetic tape, programmable memory device or any future device, or a transient medium such as an electrical, optical, microwave, RF, electromagnetic, magnetic or acoustical signal. An example of such a signal is an encoded signal carrying a computer code over a communications network, e.g. a TCP/IP signal carrying computer code over an IP network such as the Internet, an intranet, or a local area network.

Embodiments of the present invention provide the translator with an environment in which he can minimise the labour involved in post-editing MT output to human quality. Embodiments of the invention use some of the techniques of TM systems but the adaptations provided by the present invention make these techniques much more general and powerful.

### DESCRIPTION OF THE DRAWINGS

Embodiments of the present invention will now be described, by way of example only, with reference to the accompanying drawings, in which:

FIG. 1 is a block diagram, showing an apparatus for implementing an embodiment of the invention;

FIG. 2 is a computer screenshot showing a text alignment window in one embodiment of the invention;

FIG. 3 is a flow chart, showing a summary of the editing and translation process in one embodiment of the invention;

FIG. 4 is a computer screenshot showing a string replacement window in a further embodiment of the invention;

FIG. 5 is a computer screenshot showing a replacement mapping window in a further embodiment of the invention;

FIG. 6 is a computer screenshot showing an EDIT mode for creation of new macros in a further embodiment of the invention;

FIG. 7 is a computer screenshot showing a phrase rearrangement window in a further embodiment of the invention;

FIG. 8 is a computer screenshot showing a macro profile manager in a further embodiment of the invention;

FIG. 9 is a computer screenshot showing a profile execution manager in a further embodiment of the invention;

FIG. 10 is a computer screenshot showing details of profile execution in a further embodiment of the invention;

FIG. 11 is a computer screenshot showing an example of a macro selection box to copy macros to a different profile, in a further embodiment of the invention; and

### DETAILED DESCRIPTION OF THE PREFERRED EMBODIMENTS

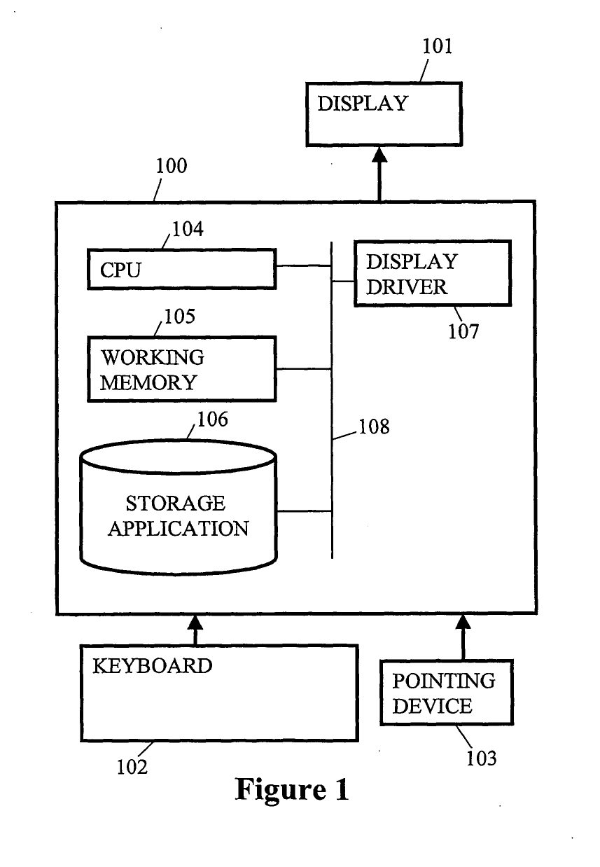

FIG. 1 is a block diagram showing an apparatus for implementing an embodiment of the invention. The apparatus includes a computer 100, which is connected to each of a display 101, a keyboard 102 and a pointing device 103. The computer 100 includes a central processing unit (CPU) 104, a working memory 105, a storage application 106, a display driver 107. The computer 100 also includes an internal bus 108 for transferring data between the CPU 104, working memory 105, storage application 106 and display driver 107. The computer 100 is configured to accept user input signals from the keyboard 102 and pointing device 103. Using the CPU 104, the computer may run software stored in the working memory 105 and/or in the storage application 106, and generate control signals to operate the display, using the display driver 107.

In one embodiment, the computer 100 is configured to generate control signals on the display driver to cause the display 101 to show a highlighted selection of pre-translated text and a corresponding highlighted selection of translated text. In a further embodiment, the computer 100 is configured to implement at least one of a selection of automatic or partially automatic editing processes, to reduce the workload required of a human translator. In a further embodiment, the computer 100 is configured to store and organise collections of these editing processes, for future re-use on a new input text. The computer may be configured to run a machine translation engine, which may be implemented by computer software code stored in the working memory, and a lexicon of words with corresponding translations, which may be stored in the storage application 106.

Embodiments of the present invention may comprise a suite of programs each of which is designed to handle a specific aspect of the post-editing function, or a single program with a plurality of different functions.

Preferably, some or all of the following functionalities are provided:
Text alignment, pre-translation and regularisation
Local editing
String processing
Lexical and syntactic analysis and pattern processing
Profile management
Post-post-editing

Each of these functionalities is now described in detail to explain how it operates and how it is integrated into the general processing flow.

The preparation of the input foreign text for the MT system is generally known as pretranslation and it can make, potentially, a significant difference to the quality of the MT output.

In preferred embodiments of the invention, text alignment functions are provided to present the text in the optimum manner for post-editing processing. The presentation of the two parallel texts can be co-ordinated as ergonomically as possible, so that the translator can follow his position in the two documents with maximum convenience. It should be noted that this function would be highly useful even if the translator makes no further use of the additional functionalities provided in some embodiments of the invention. The need to correlate source and target material is a general requirement of all translation.

A significant ergonomic factor for translation is the need to follow two texts simultaneously. This requires a considerable amount of ocular cross-referencing, which could be shown to produce a substantial slowing in the rate of output of the human translator. The problem is directly addressed by the Trados TM system, which provides a “workbench” window, which automatically presents the relevant source text sentence and matches it with any matching previous sentence that is available. This means that the translator never has to find the source sentence before proceeding to translate it. The Systran MT system also addresses this problem by providing an alignment mode in which both texts appear in a split screen and selection of a sentence in one part of the screen automatically highlights the corresponding translated sentence in the other.

Both existing systems have shortcomings. The Trados-type system is rather inflexible about moving from sentence to sentence, since the workbench has to be refreshed each time a sentence is accessed and this can take some time. This problem is avoided by the Systran-type method, but at the expense that it is necessary to work with html files in this mode rather than with Microsoft Word documents or other user-editable documents. One embodiment of the present invention offers a system which correlates post-edited output both with MT output and with the original source. This enables the translator to correlate his intervention in the text at any given time with the location in the original document and to monitor the post-editing changes that have been made since the MT run. Additionally, the differences between the translated text and the post edited text may be highlighted, e.g. by showing them in a different colour to the rest of the text. This enables very precisely targeted editing of macros, whose effect is highlighted in a variety of contexts. In general the contextual sensitivity of string and pattern macros is a major advantage of the system in all embodiments.

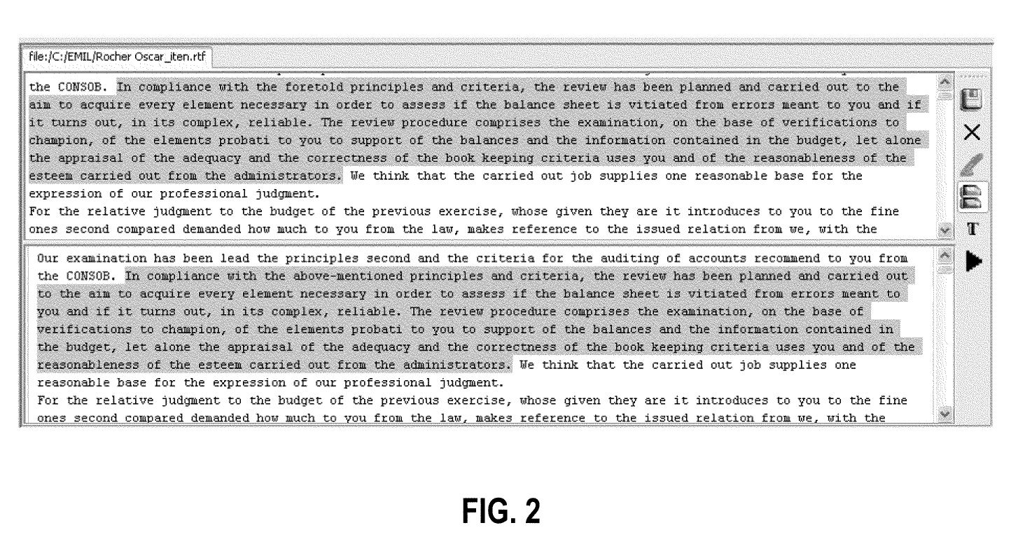

FIG. 2 shows a computer screenshot of a text alignment window arrangement in one embodiment of the invention. Two text windows are shown within an application window, the application window having control buttons at the top to provide a user interface for accepting a user's instruction to save the text, and/or implement various other editing and/or display functions. One of the two text windows may be configured to show the text prior to translation, or it may be configured to show the translated text prior to any post-editing changes made by the translator. The other text window may be configured to show the editable translated text, such that the translator may directly make edits to the text that is displayed in this window.

In the example shown, the first window shows a machine translation output, in English, and the second window shows the post-edited version of the machine translation output. The first two sentences of the second paragraph have been highlighted in the first window by a user. The machine translated output text shows several imperfections, such as “the foretold principles and criteria” in the first highlighted sentence. This defect has been corrected in the post-edited version of the text displayed in the second window, by the translator. It is easy for the translator to correlate the two texts, because the text corresponding to the highlighted part of the first window has been automatically highlighted in the second window.

The user may manually highlight a particular part of the text, by selecting it, e.g. with a mouse or other user input device. Alternatively, sections of the text may be automatically highlighted, one at a time. When a user is satisfied with the edits made to a particular section, he can choose to select the next section. In some embodiments, the user may have the option of re-selecting the previous section for further editing. The user may select parameters to determine the length or characteristics of automatically highlighted sections in some embodiments. When the user selects a different sentence in the first window, by any of these selection methods, the highlighting in the second window will be updated to correspond to the newly selected text.

In preferred embodiments, the post-editing feature may operate using any type of input and output text files, e.g. rtf (rich text format) files, Microsoft Word documents, other common word processor document formats, html (hyper text markup language), pdf (portable document format), etc. Editing and saving functions are available, and the translator can easily refer to the surrounding context sentences rather than just the current sentence, as is not the case with “workbench” systems. If the translator does not wish to correlate with the interim MT output text (but instead correlate the post-edited output text exclusively with the original source text, for ease of consultation), he will be able to disable this function through an optional setting. This method of alignment has the further advantage of being more ergonomic than the systems of parallel-column text presentation used by other TM systems, such as Deja Vu, and other MT systems, such as Reverso/Promt. Such systems also involve a need to reintegrate the translation file into the eventual output document.

A further useful preliminary function provided in some embodiments of the invention is the ability to identify the language from which the MT output has been created. This can then be assigned as a property to a profile to be used, where the profile defines a set of automatic editing processes e.g. macros. This assignment of the language to the profile allows verification that all the macros (including string matching and pattern matching macros) in the relevant profile are marked for their language of ultimate origin, thus making it immediately possible to detect macros which have, through a mixing error, found their way into a profile relating to a different language. As profiles grow in size and are used across and between individual translators or organisations, this danger becomes increasingly real. Through the identification of the ultimate source language, a profile may be as well protected from this threat as a conventional TM translation memory simply matching sentences across two different natural languages. A profile may be configured to indicate both the source language and the translated language. If a text has been translated more than once, the profile may contain details of each language involved in the chain of translations. The profile may also indicate the language type, e.g. oriental language, Germanic language, computer programming language, etc. The profile may also include settings used for MT.

A significant source of difficulties for MT systems is that the source texts themselves suffer from various forms of imperfection. These can broadly be divided into those which are already intrinsic to a “soft” electronic document and those which are specifically attributable to the production of editable documents, e.g. by OCR processes or by speech recognition processes.

The characteristic problems of soft texts mainly fall within the two areas of spelling errors and grammatical irregularities that are already covered by many conventional systems. For the purposes of preparing a foreign language document for MT input, it is not necessary to have an interactive process for spelling and grammar checking such as is available in standard word processing packages. The process may largely be automated. This would be straightforward in the case of spelling (with doubtful cases being left to be picked up by the human translator later in the overall process) and could also run through more or less automatically with grammar correction following a specified list of very simple grammatical errors (such as stray white space or so-called broken text, particularly in table columns). It may be that more extensive intervention than would be justified is required to achieve a “perfect” source text. However, it would be possible to eliminate a considerable number of low-level errors which slow down subsequent processing.

The use of output text from OCR poses further difficulties. OCR technologies are rapidly improving and they obviously offer scope for a huge increase in the use of MT, but, except in highly favourable situations, they are likely to remain prone to various problems for a considerable period. Two examples which might be mentioned at this stage are that the spellchecking function will need to be more extensive than with a soft text and deal with a different characteristic pattern of error and that OCR often produces broken text in the form of line breaks interrupting the flow of sentences. This is a particularly serious problem with translation from a language involving particularly heavy word order rearrangement. Embodiments of the invention may offer functionalities for example for eliminating line breaks not justified by punctuation. This may lead, in some cases, to over-generalisation, but that could be contained by exceptions or removed in later processing.

The use of speech recognition introduces different types of error, e.g. similar sounding words may be incorrectly identified. Simple grammar checks may automatically eliminate some of these errors, in some embodiments of the invention. The speech recognition may be used to produce the original source text, or a human translator may use speech recognition software to input his translation of the source text. In either case, by identification of the speech recognition process as a potential source of a particular type of error, automatic corrections may be made to improve overall performance.

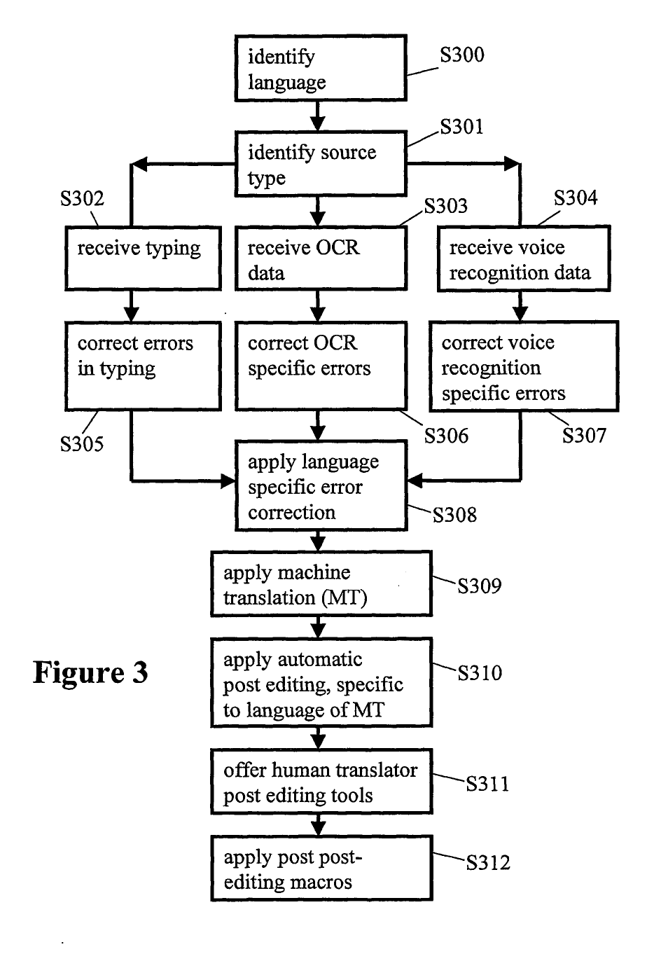

FIG. 3 is a flowchart, showing a process of editing and translation that is dependent on the source type of the text to be translated, according to an embodiment of the invention. The process starts at step S300, in which the computer 100 identifies the source language of the text to be translated. The computer 100 may do this, for example, by analysis of the vocabulary of the source text, or by alternative statistical or pattern analysis, or by reading information associated with the text that identifies the language, or by accepting a user input to identify the language.

Next, at step S301, the computer 100 identifies the source type. For example, the source text may have been input to the computer (or to another computer and transferred) by typing on a keyboard, by optical character recognition (OCR) or by audio speech recognition. The computer 100 may identify the type of source text by statistical and/or pattern analysis of the source text, for example, to attempt to detect the type of error that would be expected by a particular form of input. Alternatively, the source type may be identified by user input, or by the computer reading information associated with the text file that contains information about the source type.

For example, OCR input may result in lots of additional white space being found in the text, and/or particular types of reading error, e.g. a higher proportion of certain characters being detected than would be expected, due to the OCR device incorrectly detecting certain characters more easily than others. Speech recognition input may contain different types of errors, for example, a high incidence of words that sound similar being identified incorrectly. Also, background sounds may result in additional words being “recognised” that were not actually present, thus in some embodiments, speech recognition input type may be recognised by grammar analysis of the text.

In the embodiment of FIG. 3, any text not identified as OCR input or dictation input is assumed to be typed input—this may mean typed on the computer 100 via the keyboard 102, or it may alternatively mean typed on another computer and transferred to computer 100, e.g. via a network or a disc. However, characteristic errors may also arise in typed text, such as accidental substitution of adjacent characters. In further embodiments of the invention, typed text may be positively identified, and a fourth category of source type “other” may be used for text that does not have characterisable errors, or for which the source type is unknown. It may be advantageous for the computer 100 to have identified the language before identifying the source type, because knowledge of the language may be helpful in identifying the likely source type.

In the embodiment of FIG. 3, if the source is identified as typed text at step S301, then the software running on the computer 100 receives the typed text at step S302, corrects errors in the typing at step S305, and the process then proceeds to step S308, where the computer 100 performs language specific correction. If the source type is identified as OCR at step S301, then the software running on computer 100 receives the OCR data at step S303. The next step is that the computer 100 performs OCR specific correction at step S306, followed by language specific error correction at step S308. If the source type is identified as voice recognition at step S301, then the software running on computer 100 receives the voice recognition data at step S304. The next step is that the computer 100 performs voice recognition specific correction at step S307, followed by language specific error correction at step S308. In some embodiments, the software offers the possibility of creating specific OCR profiles, which remove persistent defects from a single OCR source, for example removing errors arising from printing characteristic of a particular fax machine. This may be more convenient than the use of the editing functions of the external OCR engine, for example in the event of a change of OCR supplier or in organisations using several different forms of OCR software. After the language specific error correction at step S308, the computer 100 performs a machine translation of the text at step S309. Next, the computer 100 performs any automatic post editing processes at step S310. The computer 100 then offers the use of post-editing tools to a human translator at step S311, for post-editing of the text. Finally, the computer 100 performs post post-editing at step S312, for example, checking for adjacent duplicate words or other errors.

In alternative embodiments, some of the steps of FIG. 3 may be omitted, or may be performed in a different order. For example, in some embodiments, language specific error correction is not performed until after the machine translation process.

In further embodiments of the invention, the translated text may be obtained from an independent or alternative source, rather than via any pre-translation processes followed by a machine translation process. For example, a post-editing system according to the present invention may be used for post-editing of translated text obtained from other sources, such as human translations. E.g., if a human translation was performed into a language in which the translator had some knowledge but was not fully fluent, it would be advantageous to use a system according to the present invention to allow another human translator to check and edit the translation, or to allow the original human translator to perform error checking routines on his translation.

In addition to the processes applied to the source language input to the MT engine, in some embodiments, editing processes may be performed automatically on the MT output, before post-editing by a human translator begins. These processes may deal with certain features of the MT output that can be regularised automatically without the need for human intervention. For example, this is potentially useful for choice of orthography and the handling of figures and dates.

In the area of orthography, the clearest switch would be the change from US English to UK English (or other English). This could be carried out to preset specifications. This could also cover the use of other, more local, orthographic conventions. Similar rules, could, of course, also be used for similar affinities between other languages, such as the two forms of Norwegian or Greek or the differences between European and South American Portuguese.

Another area where regularisation is useful is that of numbering and date conventions. Embodiments of the invention may provide “off-the-peg” profiles for the punctuation of numbers and the component-sequence of dates. The desired format can be set from document to document in line with the requirements of the end client and it will also be possible for the input specification to have a certain amount of fuzziness to allow for semantically insignificant variations in the dates/numbers produced by the MT output.

In some embodiments, after this regularisation pass, the next stage of the processing of MT output will standardly comprise the application to the text of one or more profiles, containing an indefinite number of string and pattern macros. These profiles may either be selected manually or determined automatically on the basis of parameters relating to the text input by the end-user of the translation or set as defaults for a particular client. This will make it possible for the profile pass to take place entirely in line with remotely determined parameters in real time. The user may submit the text, e.g. through a web portal, and then contribute a specification of parameters and/or options to guide the profile selection process. In some embodiments, in favourable cases, this text-specific profile selection will itself be able to perform a large and increasing portion of the overall post-editing work required. After the completion of the profile runs, the now enhanced text will be available for further post-editing as necessary or desired and the result of such post-editing can also be stored in existing or new profiles.

In preferred embodiments of the invention, with the place in all three texts being clearly and simultaneously presented, the translator may at this stage be given a range of tools for convenient and efficient post-editing. Some of these tools may be used in the immediate location without any further effects either later in the same text or for future texts and other tools may be precisely intended either for global application across the document or to create material for future reuse (in the manner of TM). The tools may be customised on a language-specific or context-specific basis, for instance in connection with the insertion or deletion of articles or automated replacement of prepositions.

An important problem with MT output is that even if the individual phrases of a sentence are correctly reproduced, the overall arrangement and sequence of the phrases may be unsuitable for the target language. Dealing with this problem involves moving substantial blocks of text, which requires first selection and then dragging. This process is made much easier in embodiments of the invention, because the relevant phrases are identified and highlighted. It is then possible to “pick up” the relevant segment with a single click and move it easily to the desired position. In other embodiments, this process itself may be partially automated by present rules for phrase sequence preferences, for example along the lines of the TMP (time-manner-place) rules for German phrase order.

The software carries out a phrasal segmentation of the MT output sentences and highlights the segmentation result according to a colour code, e.g. red=noun phrase (NP), yellow=prepositional phrase (PP), blue=verb phrase (VP), etc. This immediately displays the phrasal structure of the sentence. Adjective phrases (AP) and adverb phrases (AdvP) may also be identified and colour coded. Other forms of coding display are also possible. It is then possible to rearrange the phrases which are treated automatically as blocks. The string and pattern processing functions may automate so far as possible the word order errors inside the phrase, whereas the overall sentence structure may be more likely to yield to enhanced local intervention (subject to the possibility of partial automation indicated above).

One difficulty that this phrase rearrangement function will encounter is that the MT output segmentation does not always reflect the true segmentation of the original source text. In addition to the problem of the distortion of the word order inside the phrase (to be dealt with by string/pattern replacement) and the problem of the sequential order of the phrases themselves (to be dealt with by the phrasal rearrangement function just described), it is possible for individual words from time to time to be displaced during translation from their original phrase into an adjoining phrase. It may be possible in later versions to develop a highlighting function to flag an anomalous entrant in the (host) phrase structure. It would then be for the human editor to reallocate the displaced word to its proper phrasal context. It is not possible to automate completely the detection of strays, but it is possible to use the macro recognition function to highlight phrasal contexts in which there is an increased risk of the presence of strays. The criteria for such patterns could be set on the basis of the ongoing processing results of the individual document. These stray elements are among the most disconcerting defects of MT output for human post-editors, since they represent error patterns that are particularly far removed from human practice. In some embodiments of the invention, the problem is made considerably less serious by being made transparent.

Local one-off word order rearrangement is a major element in any MT post-editing which cannot, at present, be wholly automated. For this problem, embodiments of the invention may provide standard drop-and-drag functions supplemented by intelligent case and punctuation change. For example, when a word is moved to the front of the sentence it may be automatically capitalised and when it is moved from the front into the body it may be automatically decapitalised. Stray punctuation and white space, such as commas adjacent to full stops, may also be automatically tidied up. In further embodiments, these functions may be enhanced and customised by the user, possibly involving automatic agreement functions for number and (in non-English languages) case and gender.

Another major local factor in post-editing is the use of words that are pervasively heteronymous even across a single text. A good example is the German word Anlage, which can mean (at least) investment, system or annex. In such cases, it is not advantageous to have a global replace function and each instance needs to be handled individually. This process can, however, be facilitated by an autotext function (similar to that in standard word processors), which provides enhanced functions for finding and deploying the text to replace the word to be eliminated. For example, if an MT output persistently translates Anlage as system, the autotext function can easily be trained to offer either investment or annex as the replacement, e.g. after the appropriate hotkey is pressed by the user. A further method for handling heteronymous terms is the use of suspended generalised replacement, discussed below in the context of cross-text and trans-document editing.

In an extension of this approach, a thesaurus type function is provided, in which possible alternative translations are standardly provided. Reverso, for instance, provides alternatives (e.g. include/understand for French comprendre) in the text itself, but this is rather inconvenient as it involves selection and deletion. Since, in the preferred embodiments, the human editor can simply click on, say, a form of include and see it replaced with the morphologically corresponding form of understand, this is much more efficient (and if the replacement was not automatic, a range of choices may be provided in thesaurus mode).

The concept of a right-click thesaurus function may be further extended. The autotext replacement options may be customisable by the human editor. The preferred alternatives may be automatically offered and a click sequence or possibly hot key deployment is used to select the preferred entry. The customisation for the autotext entry may vary not only from document to document but also from section to section within a document. The human editor may be able to change the substitute text prompt an arbitrary number of times and also the prompting sequence. Also, generally available terminological sources may be plugged into the thesaurus function. These may, in principle, range from proprietary glossaries to public on-line dictionaries or commercial software dictionary applications. The latter function is particularly useful for dealing with individual source language words that survive the MT process.

A special case of this phenomenon is that of prepositions, which represent a notorious difficulty for automated translation. For example, the French preposition a can range in meaning from to on to for to with (with other possibilities also no doubt being available from time to time). In a preferred embodiment, this problem can be handled by a hot key function that offers interchange between all the possible target prepositions and the near-source language preposition (which may occasionally survive through the MT process into the post-editing input). This may be fully customisable for the convenience of the user. Prepositional phrase issues may also be significantly addressed by anchored pattern replacement as discussed below.

For frequent minor changes (e.g. insertion (in Slavic) or removal (in Romance languages) of articles), which in fact account for a sizeable percentage of the post-editing workload, it is possible to have an automatic inserter/remover for a specified range of words (e.g. articles and/or prepositions). A similar function may also be available for reversing local word order. One important case is that of adjectives/participles followed by nouns, but it may be possible to extend the function to permit reversal of the order not just of two words but of a word and a phrase or even of two phrases. For example, if the output from machine translation from a French text was: “policies and strategies national and international”, the order-reverser could, with a single click or key-stroke, move it to “national and international policies and strategies”. The reverser, that is to say, would have an inbuilt local segmenting function.

The reverser may also be developed further to have a hierarchical scale within the relevant sentence tree. The editor would be given the choice of reversing the structure at the token level, at the conjunction level, at the immediate phrase level or at the higher phrase or clause level. This would effectively automate the segmentation process as the input to flipping, thus halving the workload of the task. The choice of hierarchical flipping level could be made available to the user through a right-click drop down user interface.

The above described tools may be used at a local level to greatly increase the ease of operation of the translator where general automation is not possible. However, further embodiments of the invention provide the powerful features of global changes, possibly including projection to future documents. Global changes may be performed at a level of string replacement and/or at a level of parsed pattern replacement. The latter is a more powerful technology, which extends beyond the reach of standard TM systems. The former also has major advantages over conventional TM.

Two of the major advantages provided by embodiments of the invention in this area are that the string replacement works at sub-sentential level, whereas TM systems standardly only offer reuse of whole sentences. Also, the changes, rather than being stored for resubmission, may be projected across the document in advance, which means that the need to confirm obvious changes is removed.

Another feature of conventional TM is that it offers “fuzzy matches”, which means that a replacement sentence is proposed even if it is not a precise match, but a very/fairly close match (depending on the user setting). This increases the power of TM systems beyond that of the find and replace functions of word processors. However, these functions are purely statistical without being semantic in any way. In conventional TM, the fuzzy replacement function is based on a predetermined ratio of data equivalence, although more sophisticated tools are also possible. In addition to the parsed pattern replacement function to be discussed in the next section, embodiments of the invention also offer, at the string level, a function of morphologically sensitive replacement, in which the fuzzy changes are guaranteed to be appropriate. This also reduces the “bureaucratic” work that the translator must do, and it can be customised to suit particular requirements.

A further possibility in preferred embodiments is for anchored pattern replacement in which a pattern is replaced only if it is associated with a particular word or words. This is significantly more effective than the rival TM approach since it subcategorises contexts in which replacement is desirable rather than simply offering an imperfect match for a range of contexts, in some of which the change is appropriate and in others not, so that considerable further work is required to reach the right end-result.

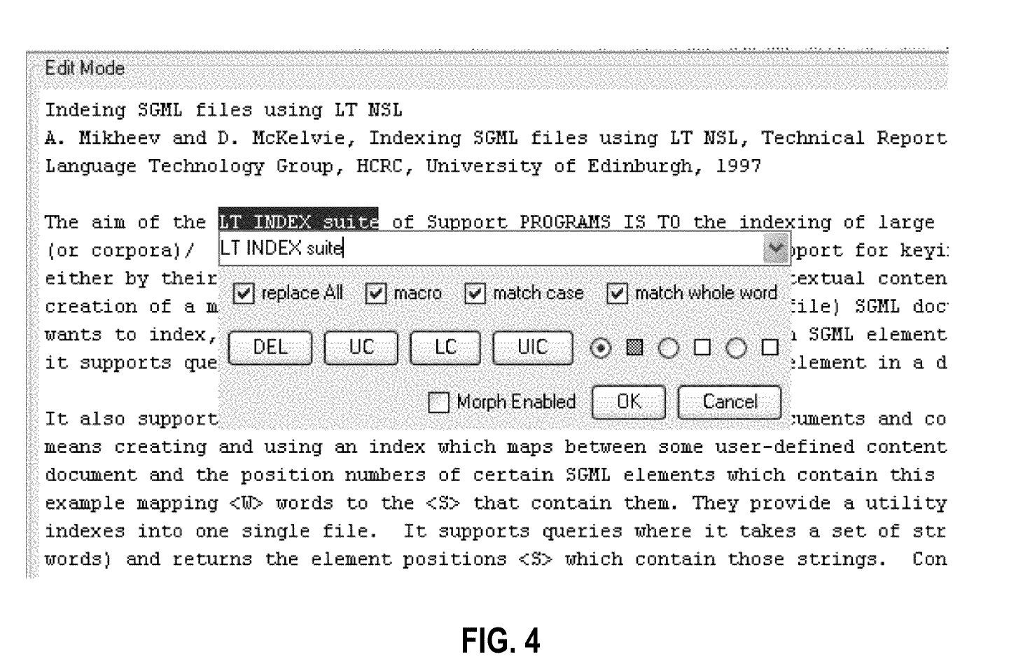

In some embodiments of the invention, string replacement may be carried out through a string replacer window which pops up when text is selected and right-clicked. FIG. 4 shows an example of a string replacer window in one embodiment of the invention.

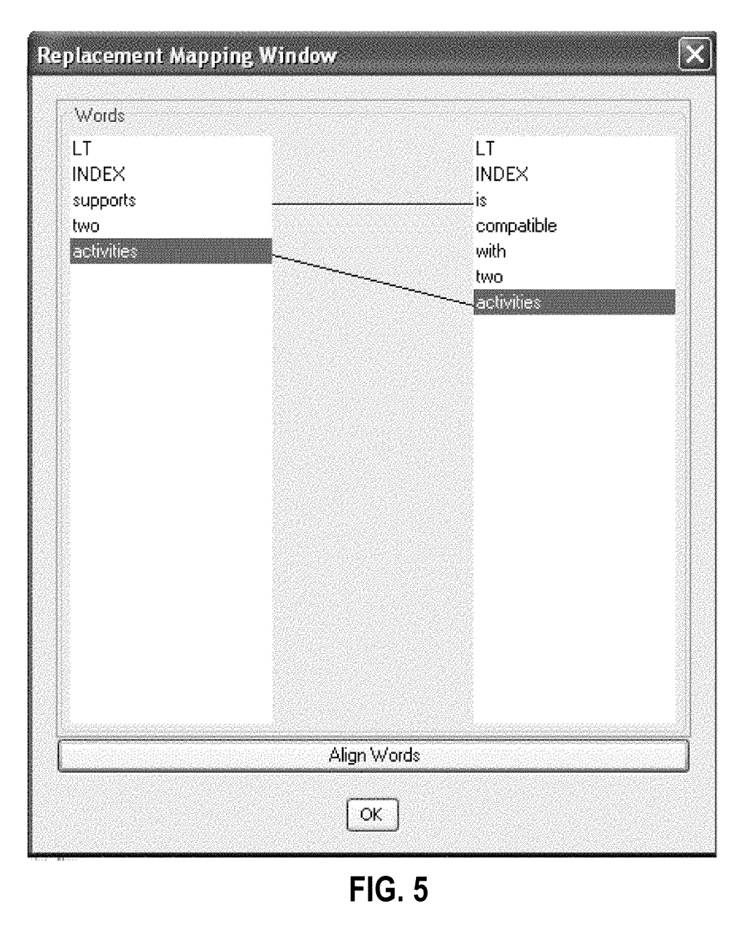

In this example, the maximum length of the string can be set by the Options drop down list, but the advantage of the function is best achieved with strings of up to about five words. The window has a replacement entry box in which the new string can be inserted. It has a function for prompting strings as close as possible to the replaced string from the existing bank of strings already replaced, and a drop-down list with easy finding functionality is provided if the user would like to look further for a suitable replacement string. This enhances both ease of operation and consistency. If no string is available, the user can simply type or dictate in the string of his choice. Once the string has been entered, the user can decide whether it should be a global replace within the document but not beyond it or be recorded as a macro for possible future use whenever the same string recurs in future documents. This can be done with standard specification of case and sensitivity and use of whole words. It is also here that the morphological recognition features can be applied. For instance, if the French phrase formulaire de registration is to be changed to registration form this can also automatically take place with the plural instances. FIG. 5 is a computer screenshot showing a replacement mapping window in an embodiment of the invention.

The morphological replacement function is more powerful still in that it contains an intra-phrase alignment feature. This enables the post-editor to select a phrase of arbitrary length (in practice up to about ten words) and make systematic alignments between any or, in principle, all of the words in the phrase with a replacement phrase, such that each replacing word will apply in the same phrase after the change with the morphological adjustment function. For instance, if the MT output text reads as follows: The body grants permits to seekers half-yearly, by using the alignment function we can match the word body with authority, the word grants with issues, the word permits with licences, the word seekers with applicants and the word half-yearly with semi-annually. This means that not only will a recurrence of the precise phrase be appropriately replaced (as with MT), but so too will morphological congeners be. For example, The body granted permits to seekers half-yearly will now, appropriately, become The authority issued licences to applicants semi-annually.

This alignment function also has another important and powerful feature, already mentioned above, by which the general replacement can be suspended. This means that the change works through the document and if, in a particular instance, it is inappropriate it can be cancelled or another replacement can be made, e.g. using a “Debug mode”. This may also apply to the firing of appropriately marked macros at the time of the imposition of a profile on a new document, as discussed below.

When the change is made globally across the document, a metrics feature may be provided to indicate immediately how many changes have in fact been made. For experienced users, this is highly advantageous, because the level of change of one phrase will often be a guide to that of one or more other changes, making it possible to decide whether a global change will be advantageous. The metric results may be capable of presentation in a variety of formats to maximise utility for subsequent macro planning.

If the change is to be projected to future documents, it may be entered as a macro which is included in a profile created by the user for this particular document or for a series of documents. The creation, editing and use of these profiles are described below.

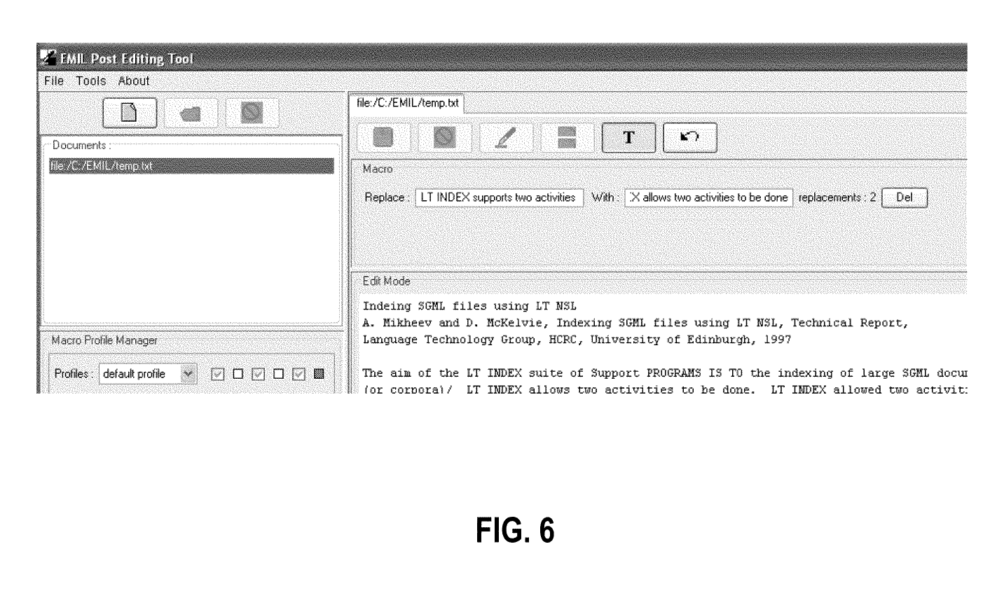

In both string and, possibly, pattern processing, it will be possible to extend the replacement function to include near misses (according to standard TM fuzziness matrices—or with enhanced use of the regular form concept). This is particularly useful with OCR output text and for dealing with non-semantic defects in the source text in general (e.g. typos, punctuation differences and stray white space). The level of fuzziness may be set and/or fuzzy dimensions may be selected (e.g. sensitivity to particular parts of speech, greater weighting for punctuation, selection of sentential, phrasal or verbal weighting, etc). An interactive box may be provided to enable the editor to respond on a case-by-case basis to the inclusion or exclusion or individual replacements. FIG. 6 shows a screenshot in an edit mode, where new macros can be created and edited.

A potential weakness of operating at the phrasal level, is that (fuzzy) recurrences at the sentence level may be missed. This is the strong point of conventional TM systems. For this reason, there is a danger that local editing work done on the first occurrence of the relevant sentence will not be recovered for use with the latter recurrences. This problem can be solved by the provision of a TM backup function, which correlates edited sentences as they are completed with the corresponding MT output sentence, with allowance being made for the application of strings to that sentence. The TM backup thus pairs the final edited output with the MT output subject only to the generalised processing (and not the local editing). In this way the local editing can automatically be recovered if the occasion for it recurs, thus eliminating the residual possible advantage of TM systems.

The TM backup function may first replace sentences in a new text which are matched with sentences in the legacy corpus and may then exclude those sentences from further processing. It may then identify matching sentences within the new document—using the preselected degree of fuzziness—and flags them as matched so that the user can stipulate the replacement of the corresponding subsequent matching sentences with the end result of the processing of the initial sentence. It is also possible for the TM to indicate the number of sentences that meet the matching criteria and, if necessary, the degree of fuzziness in each case. In a preferred embodiment, the TM backup function can present the future matching sentences for immediate processing in the context of the initial sentence, so that fuzzy discrepancies can be handled systematically and in a single pass. Such matching sentences could then be marked as preprocessed for future reference as the user reaches the relevant locations.

It may also be possible for the TM backup to record tagged patterns as well as mere string similarity. The system may therefore not only be able to propose conventional TM matches, but also to suggest pattern replacements based on early pattern changes which have not, however, been entered as pattern macros. This is extremely useful because it is not possible for the human editor to be certain which patterns are most likely to recur and therefore which patterns best justify the establishment of pattern macros. The enhanced TM function will allow important missed patterns to be prompted. The human editor is then assisted with the implementation of the pattern change in the new local context and may also be given a ready-made macro which can be carried over into a new pattern macro for indefinite future use.

The string pattern replacement discussed above is more powerful than conventional TM for the reasons indicated, but there is a still greater possibility of automated replacement at the level of parsed sequences rather than mere strings. This is because parsed sequences offer the possibility of picking up syntactic patterns which prescind from the actual semantic filling. This is discussed below.

Taking the previous example of the French phrase formulaire de registration, this can already be generalised to the plural case. A more powerful form of generalisation, however, may also extend to related phrases, such as formulaire de déclaration or formulaire d'attestation. In these cases, the fact that embodiments of the invention (unlike conventional TM) understand the syntactic structure of the phrase can be exploited to achieve a rule roughly to the following effect: if found=formulaire d(e) [noun], replace by [noun] form. This is a very basic example, but the use of pattern replacement could be extended indefinitely, depending only on the expertise of the translator using the system and the amenability of the particular text.

The above example is subject to two major constrictions. In the first place, the phrase taken is extremely short. Indeed, apart from the mere reversal of order of noun and adjective, it is the shortest possible. Secondly, it only considers one particular phrase (although that phrase can be changed whenever it occurs).

This can be generalised further. It is possible to select a sequence of any arbitrary length and also make changes to it, with at least some of the same benefit as in the simple case that we have just been considering. One of the difficulties here is that over-generalisation becomes increasingly problematic. For instance, we could convert “activities of insurance and reinsurance” to “insurance and reinsurance activities” using the same rule as before, but now there is a danger that we will also take in cases in which the word after the and is not part of the phrase.

This difficulty can be circumvented by “anchoring” the pattern change within a string or a larger pattern so that contexts in which the noun following the conjunction belongs to a separate phrase can be excluded from the general automatic change. In subsequent embodiments it may be possible to build the phrase boundary recognition function exploited for phrase highlighting so as to integrate a phrase boundary marker into the pattern/syntactic replacement macro itself.

In principle, there is no limit to the length of a phrase. It can comprise what is conventionally known as a clause or even stretch to the entire sentence. It merely means a group of words combined for grammatical purposes which will require rearrangement in some way.

A typical output from an MT engine for one of the Germanic languages would be something like the following:

The(i) [on the account](ii) [credited](iii) amount(iv)

In this case, the equivalent English translation is “The amount credited on the account”. The conversion requires two changes: first (iv) must be brought in front of (ii) and then (iii) must be placed after (iv). In this case, we can disregard the need to add or delete small words and also the problems of capitalisation (though parallel problems of the treatment of punctuation, especially commas, may well arise).

It is possible to have the advantages of simplified drop and drag here, but the functionality may be modified to allow for the fact that it is not individual words but subsidiary phrases that have to be dragged. The ergonomic advantage may depend critically on the ease of selection of (ii).

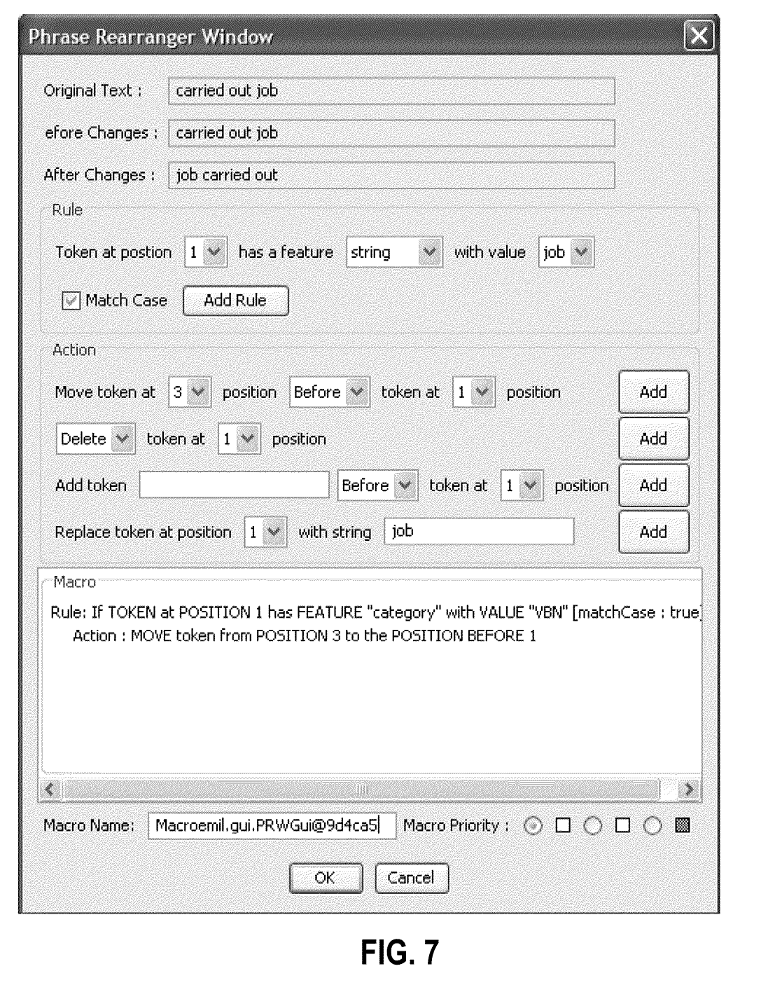

The precise resultant converted phrase could then be entered in a global macro. FIG. 7 shows a screenshot of a phrase rearrangement window, used to set up a phrase rearrangement macro. A phrase rearrangement macro may be similar to the macros already considered for the string replacement function, except that its application and reuse would require a greater degree of processing because of the greater informational complexity of the structure. It could be used for a profiling run across new texts and also for the suggestion of alternatives in future drop-downs of the kind just discussed. It is also possible for the morphological variation assimilator described earlier to operate. This will be even more important in other languages than in English, but even in English there is at least the morphological variation between plural and singular. Thus, at least the following phrases should be automatically converted in the wake of the first one:

The(i) [on the account](ii) [credited](iii) amounts(iv)

The(i) [on the accounts](ii) [credited](iii) amount(iv)

The(i) [on the accounts](ii) [credited](iii) amounts(iv)

An important advantage, however, arises from extension to phrases of close structural parallelism.

Consider the following:

The (i) [from the account] (ii) [debited] (iii) amounts(iv)

(and, of course, all its direct morphological kin). It would obviously be a major advantage for this example also to be included in the automatic conversion, first in the remainder of the current document and then in all subsequent documents. For this to happen, “debited” should be recognised as the same POS as “credited”, so that, in the context, it should simply move in the precisely parallel way. Also, the appropriate preposition change should take place.

It may not be possible or ergonomically justifiable, using presently available statistical MT, to link verbs and phrasal prepositions in the sort of way that would make this change feasible. However, if the debited phrase occurred later in the document (or in some subsequent document) with the correct order of (ii), (iii) and (iv) but without the pronoun change, there would still, obviously, be an ergonomic gain, because it would then only be necessary to enter the preposition change manually and the system would automatically update the conversion lexicon.

One consequence of this, over time, would be that the profiling pass may come to take considerably longer than the original MT processing. This would, in many ways, represent a sensible division of labour. MT could continue to generate usable gisting output more or less instantly, whereas the application of pattern replacement macros could take considerably longer, although still allowing the post-editing process to improve on the turn-round times of professional translation.

We now discuss the possibility of projecting the restructuring pattern more widely across the text (and the language). These options may be made available to users as they develop familiarity with the system.

Two possibilities for doing this are now described. On the one hand, there is a pure POS phase restructurer. This may work on any phrases with the same syntactic structure (or lack of it) formulated according to some preferred basis of POS tagging. This is obviously a very powerful tool, but the danger is that it is likely to generate as many counter-instances as useful results.

A more practical resource would be a kind of hybrid or anchored phrase rearranger which would apply to the relevant phrases to the extent that they contained one or more of the actual words used in the prototype. These actual words anchor the replacement only to contexts in which the danger of over-generalisation can be minimalised. So, for instance, to revert to our earliest and simplest example, it might be possible to establish a general pattern of structure conversions in connection with the word form.

This may be extended in two ways. In the first place, it would be necessary to have a rapid and efficient method for introducing exceptions, such as “form of employment” or “form of words”. It should also, ultimately, be possible for the exceptions themselves to be grouped in some usefully projectable way. Two particularly appropriate ways of doing this are by using Boolean operators to indicate specific contexts where generalisation is not appropriate and by pre-specifying salient exceptions into the macro. Since the number of exceptions is likely to be token-heavy but type-light, such exceptions will not be ergonomically inefficient. The exception building process may also be extensively customisable through the system options.

For all aspects of exception formation it may be possible to use corpora currently available as a benchmark for optimising the efficiency of exception creation. This could be based on statistical generalisation or on a case by case review of a salient subsample of an applicable corpus. The value of the corpus reference could be raised if the corpus derived from a proprietary source of the client for which the current document is being processed.

The second line of extension is towards the introduction of words to be treated similarly in conversion. For instance, the translator might decide that any patterns that could be established around the word “form” could also be projected to the word “certificate” or possibly even “document”. The latter would be a case where the translator might well want to specify that the translation should be generalised to the document but not to the language as a whole.

In some embodiments of the invention, certain non-syntactic malformations may be highlighted without actually making or proposing changes to them. In this way the attention of the translator would be drawn to them, a function whose value will increase in an inverse relationship to the general speed of progress through the text.

These extensions of the basic restructuring device may be provided optionally, e.g. to users with higher skill and expertise levels. However, they demonstrate a progressive evolution of the relationship between the MT output and post-editing techniques, which will become particularly marked with the arrival of mature statistical MT.

Some embodiments of the invention provide a post-postediting (PPE) grammar and style checker as a further tool for the elimination of the characteristic faults of machine-generated or other translated texts. This may work on an interactive basis as a final read through of the output text. The module may pick up any obvious word rearrangements that have been missed by the human post-editor, such as subject-verb misplacements with the Germanic languages, and/or repeated phrases etc. The grammar checker tool, like other features provided by the invention, may be tailored to the individual requirements of the human editor, to some extent guided by the identification of the source language, which conditions the overall post-editing process.

In addition to the elimination of residual grammatical or syntactic errors, the engine may also be able to provide stylistic intervention. Once again, the human posteditor will prescribe certain parameters (most obviously in connection with prepositional or adjectival phrase order). Infringements of these parameters may be flagged and the human editor will be given a range of tools to intervene to restore compliance with the default specifications. This function may build on existing style-checking technology and adapt it to the particular requirements of MT postediting.

Both the string replacer and the pattern replacer produce macros, and these may be stored in profiles. A profile is therefore a set of macros. Profiles evolve over time and correspond to the translation memories in TM systems. They will therefore become valuable intellectual property in their own right. Profiles may come in two forms, those for string macros and those for pattern macros. Both essentially operate in the same way, but string macros impose a lighter processing load and are therefore considerably more rapid. In preferred embodiments, it will also be possible for these profiles to be blended and combined without restriction to create appropriate profiles even for virgin texts.

In some embodiments of the invention, an important supplementary function to Profile Manager is the Language Recognition Module (LRM). This identifies the language of the source text (even before input to the MT engine). This is useful for a non-linguistic user who will thereby be enabled first to choose the appropriate MT engine or setting to apply for the machine translation and then to select an appropriate profile to run over the output. This should mean that a person completely ignorant of, say, Chinese will be able to achieve a working draft translation of a document by making only a few settings in his system.

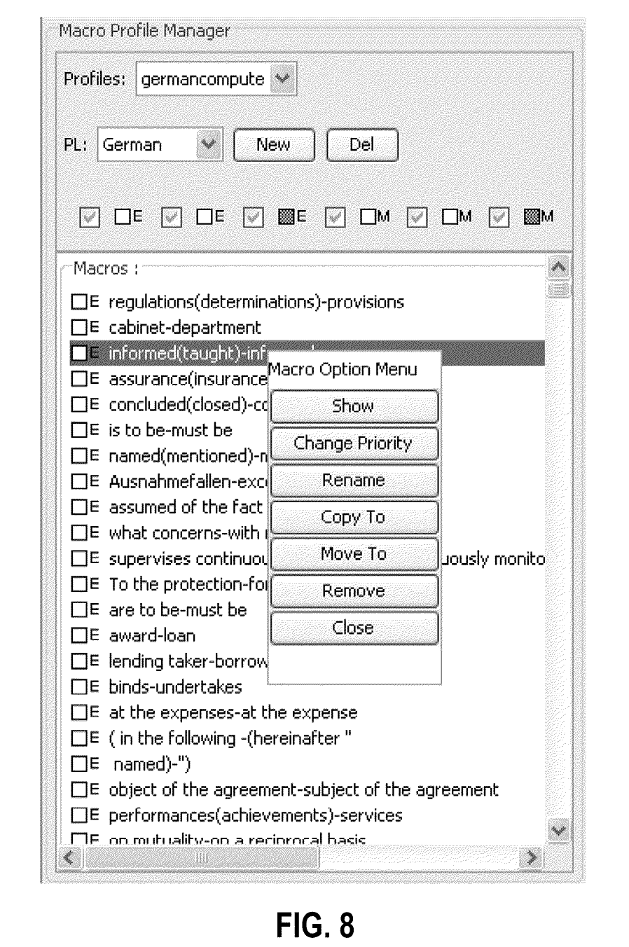

FIG. 8 shows a screenshot of a macro profile manager in an embodiment of the invention. The macro profile manager is run within a window, with control and selection buttons, and a list display area for displaying a list of macros. A profile selection button allows a list of macros to be displayed for a particular profile. Each macro in the list is shown with a macro name, and a box indicating a colour code for the macro. When the pointer is clicked on a particular macro, a pop-up macro option menu appears. In this example, it gives the options of run, show, change priority, rename, copy to, move to, remove and close. A variety of search options within profiles for macros or macro parts may also be provided so that the accumulated material can be displayed perspicuously to the reader from a wide range of perspectives.

When a new document is opened, a Profile Manager option may offer the user the possibility to run one or more profiles over it. This means that each macro in the profile finds an instance which requires replacement and duly replaces it, observing the stipulated case-sensitivity, segmentation and morphological parameters.

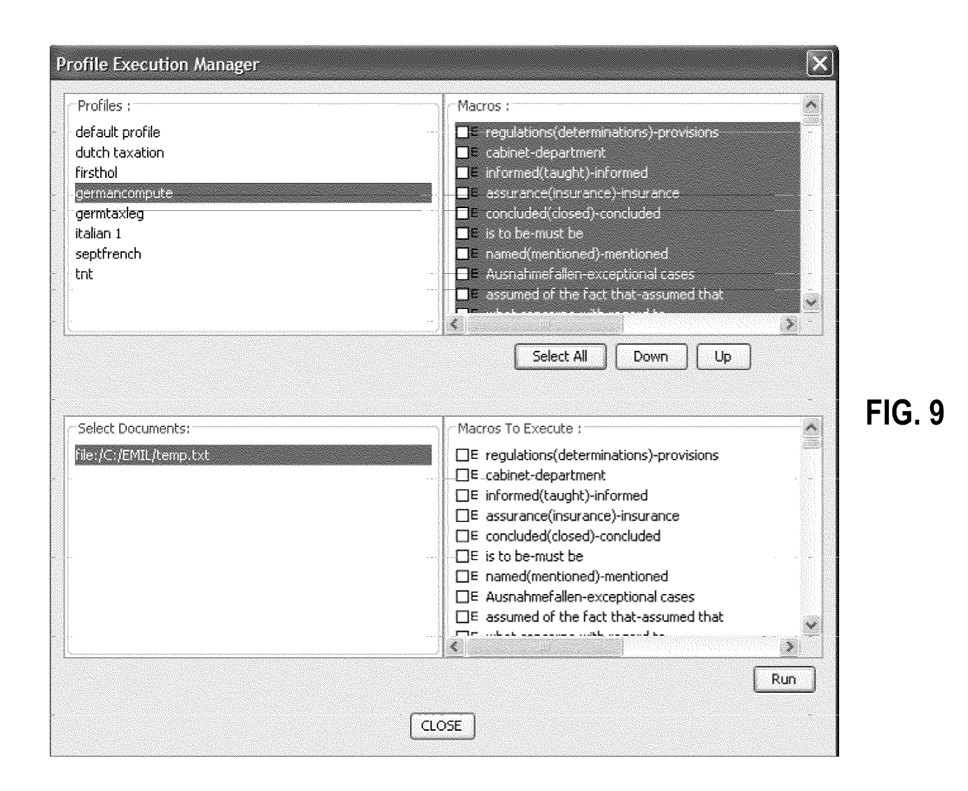

FIG. 9 shows a screenshot of a profile execution manager, in one embodiment of the invention. A first window shows a list of profiles, including “default profile”, “dutch taxation”, “firsthol”, “tnt”, “Germancompute”, “germtaxleg” and “septfrench” in this example. The “Germancompute” profile has been selected, and is highlighted in this example. A second window shows a list of macros available for use in the selected profile. Each macro has an associated colour marker, to allow it to be selected or deselected. A third window shows a list of documents to be processed using the macros. A fourth window shows a list of selected macros for the selected profile. A progress bar shows the progress of the system in executing the selected macro.

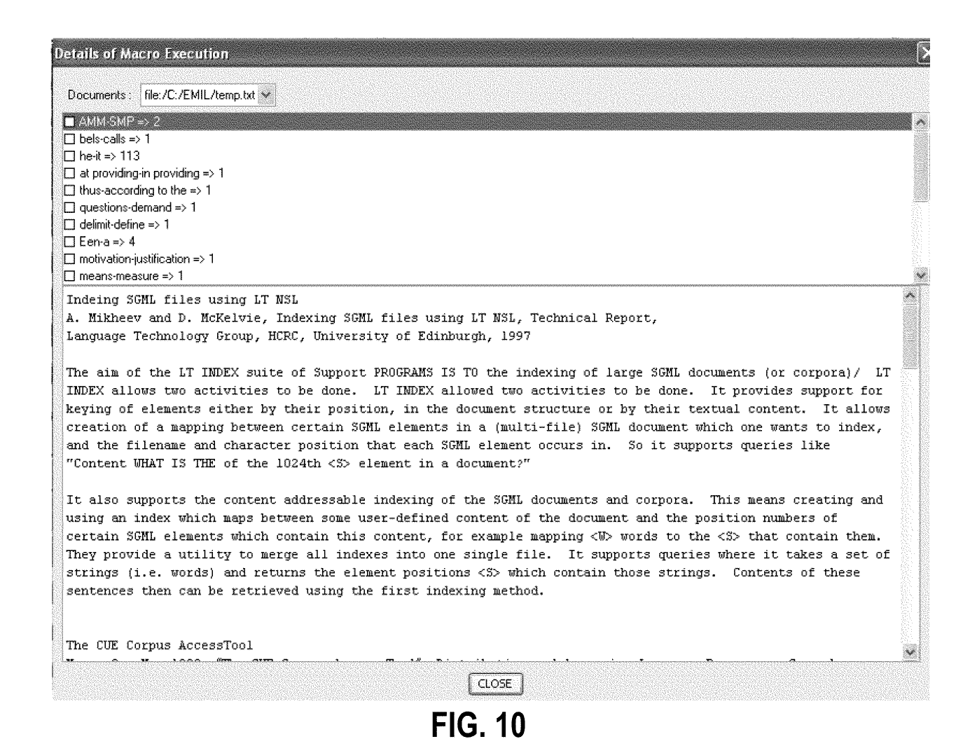

After this process is completed a metric presents the results of the pass, which is a useful indication both of the suitability of the profile selected and of the amount of work that must still be done to the text. FIG. 10 is a screenshot showing details of profile execution. A first window area shows a list of replacements, along with the number of times each replacement was made. This can be useful information to a translator, to let them know if unexpected numbers of replacements have been made, which need further investigation. The edited text, including the replacements, is shown in a second window area.

The user can then proceed to the editing of the text using the tools described above. If several texts of similar content are translated, it is to be expected that after a certain number of similar texts have been used to build up the relevant profile, the work of the post-editor will be confined essentially to local changes that are not susceptible to either string or pattern replacement.

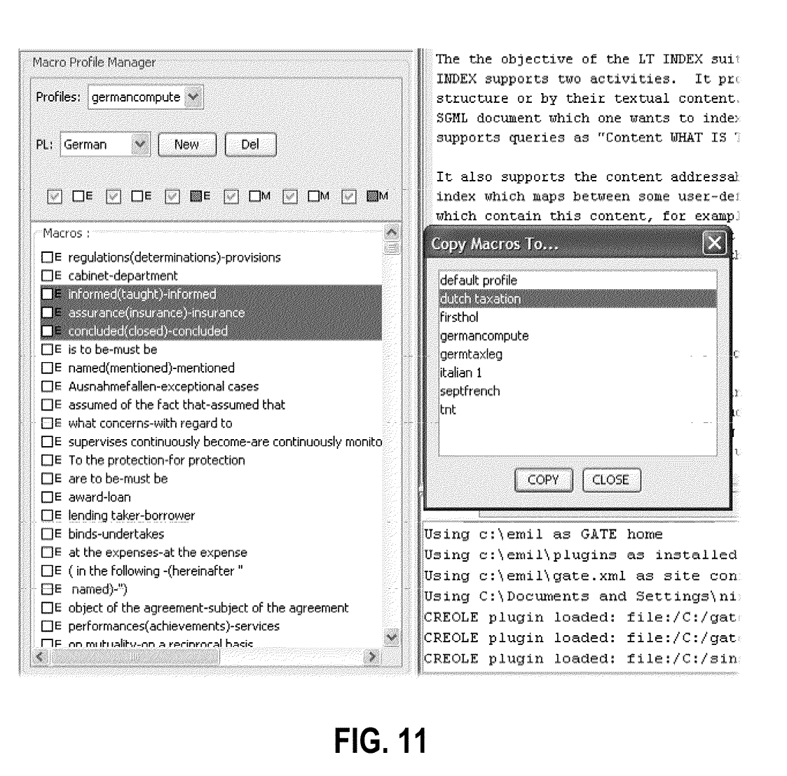

Profiles are obviously most effective with series of closely related documents—a good example is bond issue prospectuses or loan memoranda in banking or insurance agreements. But the Profile Management function also offers the possibility of reusing and recombining macros from profiles for the most effective use in new documents. For example, suppose that you have a mature profile in German for the telecommunications sector and also a mature profile for German banking agreements. You are now required to translate a German telecommunications agreement. It is possible to select from the two profiles those macros that are most likely to be useful and combine them into a new profile specifically for German telecommunications agreements. It will also, very importantly, be possible to produce profiles tailored to particular clients or particular projects. This is an especially effective way of ensuring terminological consistency, since the appropriate terminology will already have been automatically specified at the run phase, allowing no possibility for human error in the application of the lexicon. FIG. 11 shows a screenshot of a user interface for copying macros to a different profile. A first window area shows a list of macros, and in this example, three of the macros have been selected. A second window area shows the post-edited text. A pop-up window shows a list of possible destinations (i.e. other macros) to which the selected macros can be copied. A “copy” button is provided to accept a user instruction to start the copying procedure, and a “close” button is provided to exit the copying process. This is only one possible embodiment, and further embodiments are also possible e.g. with different user interface features and/or tools for managing the profiles.

It is also possible simply to run both profiles over the new text, and in many cases this would be the best way to proceed. But in certain circumstances it might be the case that macros which are useful in one context are actually harmful in another. This can apply to string replacement (as the example of Anlage suggests), but is still more relevant for pattern recognition.

The ability to “prune” profiles increases the power of modular macro structures, in which a basic set of profiles can be recombined in an indefinite number of combinations so as to provide the best initial input for any new text. This functionality may be secured by a system of flagging macros. For example, a colour coding system may be used. On creation a macro may be marked as likely to be harmful elsewhere (red), potentially harmful elsewhere (yellow) or harmless (green). This colour-coding makes it easy in the subsequent editing process to delete macros that may be harmful (or whose operation may take an unjustifiably long time). As the user develops a set of profiles, he will find that the function of post-editing itself is shifted more and more to the proper selection and editing of profiles, with obvious advantages in terms of productivity gains. Preferably, the profile contents display can also be set to display all or some selected sub-group or groups of the colour-coded entries.

The combination of macros from existing profiles into new profiles will also be greatly enhanced by the language recognition function described above. This will make it possible to ensure that macros deriving from the processing of MT output deriving from one foreign source language are confused with those deriving from another. This added level of safety will enable the human editor to adopt a less cautious policy towards the colour coding of macros, thus enhancing the leverage of the macros within the appropriate language.

A possible obstacle to translators in switching from conventional TM systems to use a system according to the invention is the prospect of losing the advantage of accumulated translation memories which, in some cases, represent a substantial asset. It is preferably made possible to import translation memories directly into profiles in embodiments of the present invention, to avoid this difficulty. A translation memory consists of the correlation of a source and target sentence (together with a certain amount of further information about the formatting and other details of the two texts). In embodiments of the invention, macros do not correlate source and target text strings, but rather MT output and target strings. However, it is a simple matter to correlate the MT output sentences with the original source sentences (namely by running the MT engine over the source text included in the translation memory). Assuming the same MT engine is then used to translate the new document, any recurring sentences will then be picked up and replaced in exactly the same way as would occur in the event of the use of a translation memory system. Thus the information about cross-language sentence correlation that is available in translation memories can easily and automatically be transferred across to profiles in embodiments of the invention. A similar advantage can be obtained by feeding macros from profiles directly into MT user dictionaries in order to optimise the interoperability between the MT engine and the post-editor.

In summary, MT is at last becoming established as a mainstream translation tool, and this trend will certainly continue in the next few years with the advent of statistical MT. The gap between MT and FHQT (fully human quality translation) will, however, persist for the indefinite future. It is a classic example of a “last mile” problem. It is relatively easy for the MT system to get near enough to the text for gisting purposes (as is now well established by Internet use) without human intervention, but the final step to full human quality still requires an experienced translator. This gap is still sufficiently wide for the viability of MT in general as against TM or straightforward traditional translation still not to be accepted. Another critical factor encouraging the development of improved MT-type technology is the steady improvement in OCR technology.

Embodiments of the invention provide the perfect environment for bridging this gap, by offering a range of tools for effective local intervention in MT output to achieve human quality and/or by maximising the effective reuse of recurring structures at both the string and the parsed pattern level.

This represents a combination of the best aspects of MT and TM. The useful contribution that the machine can already make to translation is harnessed to the full, while the possibility of accumulated repetition is also more effectively exploited than in conventional TM systems. The result is that embodiments of the invention are able to outperform Trados and its siblings even with closely related series of texts (which is the home ground of TM) and is able to make a significant contribution (once the system has matured for the given translator) to the translation of completely “virgin” texts, for which not only does TM not make any contribution but it requires the somewhat laborious process of inputting the sentence matches in the first place.

Some embodiments of the invention provide the significant advantage of producing profiles which can be reused and redeployed indefinitely (again to an extent exceeding that of TM translation memories). These will themselves evolve into a significant asset which can be marketed in tandem with the software itself and commissioned on a tailor-made basis.

Preferred embodiments of the invention are compatible with all major existing file types, for example, including Microsoft Office formats. Embodiments of the invention may operate both independently in stand-alone mode and as a plug-in to MS Word or other text editing applications. In the latter case, most of the editing functionalities of Word are also automatically available. Embodiments of the invention may also be available with other file formats, such as other formats within MS Office and various kinds of desktop publishing and web environments. Information conserved across documents in the form of macros may be equally deployable on any files irrespective of the format. Embodiments of the invention may be equally effective with a suite of documents in different Office formats as with a simple collection of documents in MS Word format.

Although the above examples relate to translation and post-editing of languages of human communication, e.g. English, French, German, Russian, Spanish, Chinese, Japanese, Italian, etc, the present invention may also be used for the post-editing of the translation of computer programming languages, e.g. C++, Visual Basic, Javascript, Java, etc. For example, a computer programmer may have source code for a program written in a first language, but wish to adapt the program using a different language. For example, the different language may run faster, or may be more up to date, or easier to use than the first language. In that case, any of the features described above may be used or adapted to facilitate the automatic translation of the computer programming language. Special features may be provided in such embodiments, such as integration with a computer programming development package. Macros specific to the above tasks may be developed and made available as separate add-ons. In some embodiments, the software may be used to support existing or future systems for the automatic inter-translation of computer languages in a manner exactly parallel to its use for the post-editing of machine translation of natural languages.

Embodiments of the present invention may also be used for format conversion of various kinds of document, or for extracting readable text from a binary file, coded file, or other data file.

While the present invention has been described in terms of what are at present its preferred embodiments, it will be apparent to those skilled in the art that various changes can be made to the preferred embodiments without departing from the scope of the invention, which is defined by the claims.

Reference has been made to the various embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The system may use any form of processor and comprise a memory, data storage, and user interface devices, such as a graphical display, keyboard, barcode, mouse, or any other known user input or output device. The system may also be connected to other systems over a network, such as the Internet, and may comprise interfaces for other devices. The software that runs on the system can be stored on a computer-readable media, such as tape, CD-ROM, DVD, or any other known media for program and data storage.

The particular implementations shown and described herein are illustrative examples of the invention and are not intended to otherwise limit the scope of the invention in any way. For the sake of brevity, conventional aspects may not be described in detail. Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. The word mechanism is intended to be used generally and is not limited solely to mechanical embodiments. Numerous modifications and adaptations will be readily apparent to those skilled in this art without departing from the spirit and scope of the present invention.

What is claimed is:

1. A text editing apparatus for the editing of text translated from at least a first language to a second language, the apparatus comprising:
a user input for receiving user instructions to select and/or edit text; and
a controller adapted to control a display to show user-editable translated text, wherein said controller comprises a pattern detector for automatic identification of phrases and/or phrase boundaries within said text, and a phrase processor for automatically selecting an individual phrase and restructuring or modification of said phrase in either its syntactic or its lexical properties or both or automatic moving of said phrase to a different part of the text in response to a predetermined user instruction or stored modification procedure.

2. The text editing apparatus of claim 1, wherein the controller is configured to modify the lexical content of individual strings of words according to user instructions or stored modification procedures, and to re-use said user instructions or modification procedures for modification of additional strings of words, wherein said re-use may include morphological changes.

3. The text editing apparatus of claim 1, wherein said controller is adapted to perform syntactic analysis of the text, and wherein said user input is configured to receive user instructions for the specification of syntactic units to be used in said syntactic analysis.

4. A text editing apparatus for the editing of text translated from at least a first language to a second language, the apparatus comprising:
a user input for receiving user instructions to select and/or edit text; and
a controller adapted to control a display to show user-editable translated text, wherein said controller comprises a processor for identification of phrases and/or phrase boundaries and for implementing automatic phrase ordering rules particular to a specified language, wherein the phrase ordering rules comprise context-specific rules, each said context-specific rule being deployed according to one or more marker words or marker expression criteria.

5. The text editing apparatus of claim 1, wherein the controller is configured to show highlighting of phrases on said display, according to the phrase type.

6. A text editing apparatus for the editing of text translated from at least a first language to a second language, the apparatus comprising:
a user input for receiving user instructions to select and/or edit text; and
a controller adapted to control a display to show user-editable translated text, wherein said controller comprises a pattern detector for automatic identification of phrases and/or phrase boundaries within said pre-translated and translated text to define a first phrase in the pre-translated text and a corresponding phrase in the translated text, and for identification of words occurring in the first phrase of the pre-translated text which correspond to words not occurring in the second phrase but occurring in a further phrase of the translated text.

7. The text editing apparatus of claim 6, wherein the controller is configured to compare phrase patterns in the text with predetermined phrase patterns and to flag differences in phrase structure between the phrase patterns in the text and the predetermined phrase patterns.

8. The text editing apparatus of claim 1, wherein the controller is configured to allow user-instructed drag and drop editing, and to automatically amend the case and/or punctuation of edited text to correspond to the new location of said text in a sentence, which may include appropriate treatment of white space.

9. The text editing apparatus of claim 1, wherein the controller is configured to identify phrases and to verify compatibility of grammatical form for words within individual phrases.

10. A text editing apparatus for the editing of text translated from at least a first language to a second language, the apparatus comprising:
a user input for receiving user instructions to select and/or edit text; and
a controller adapted to control a display to show user-editable translated text, comprising a processor for automatically generating, in the translated text, grammatical structures that are characteristic of the second language but not of the first language using a language model.

11. A text editing apparatus for the editing of text translated from at least a first language to a second language, the apparatus comprising:
a user input for receiving user instructions to select and/or edit text; and
a controller adapted to control a display to show user-editable translated text, comprising a processor for automatically removing, from the translated text, grammatical structures that are characteristic of the first language but not of the second language using a language model.

12. Computer apparatus for managing information representing text translated from a first language to a second language, the apparatus comprising: an information store for storing a first set of information representing text translated from a first language to a second language; an input for receiving user instructions for selection and/or editing of text represented in said first set of information; a text data controller for editing said first set on the basis of received user instructions; and a display data generator operable to generate display data, said display data being operable to define first and second display areas on a display medium, said first display area containing first text information corresponding to said first set of information under the control of said text data controller, and said second display area containing second text information corresponding to a second set of information, said second set of information either comprising said text prior to translation from said first language or corresponding to said first set prior to editing thereof by said text data controller; wherein said display data generator being further operable to include distinguishing information in said display data, said distinguishing information being operable to cause a part of said first text information and a corresponding part of said second text information to be visually distinguished from the remaining respective parts of said first and second texts, wherein said display data generator operable to display the other of said pre-translated text and pre-user-edited translated text in a third display area, and to highlight a part of said text in the third display area corresponding to the selected part of the text in the first display area.

13. The text editing apparatus of claim 1, further comprising a data store or interface for saving information specifying changes to the text, for use with future documents.

14. A signal or carrier medium carrying computer readable code for configuring a computer as the apparatus of claim 1.

15. A text editing apparatus for the editing of text translated from at least a first language to a second language, the apparatus comprising:
user input means for receiving user instructions to select and/or edit text; and
control means adapted to control a display to show user-editable translated text, wherein said control means comprises pattern detection means for automatic identification of phrases and/or phrase boundaries within said text, and processing means for automatically selecting an individual phrase and restructuring or modification of said phrase in either its syntactic or its lexical properties or both or automatic moving of said phrase to a different part of the text in response to a predetermined user instruction or stored modification procedure.

16. A method for the editing of text translated from at least a first language to a second language, the method comprising:
receiving user instructions to select and/or edit text; and
controlling a display to show user-editable translated text, and performing pattern detection to automatically identify phrases and/or phrase boundaries within said text, and to automatically select an individual phrase and restructure or modify said phrase in either its syntactic or its lexical properties or both or to automatically move said phrase to a different part of the text in response to a predetermined user instruction or stored modification procedure.
